(19) United States
(12) Patent Application Publication
(10) Pub. No.: US 2019/0101782 A1
(43) Pub. Date: Apr. 4, 2019

(54) DISPLAY MODULE AND TERMINAL

(71) Applicant: Wuhan China Star Optoelectronics Technology Co., Ltd., Wuhan, Hubei (CN)

(72) Inventors: Hongrui CAO, Shenzhen, Guangdong (CN); Jiehui QIN, Shenzhen, Guangdong (CN)

(73) Assignee: Wuhan China Star Optoelectronics Technology Co., Ltd., Wuhan, Hubei (CN)

(21) Appl. No.: 15/544,880

(22) PCT Filed: Apr. 26, 2017
(86) PCT No.: PCT/CN2017/082045

§ 371 Date: Jul. 19, 2017

(30) Foreign Application Priority Data
Mar. 28, 2017 (CN) 201710191131.6

(51) Int. Cl. G02F 1/1345; G02F 1/1333

(52) U.S. Cl. CPC G02F 1/13452; G02F 1/13458; G02F 1/13454; G02F 1/133305

(57) ABSTRACT

Disclosed is a display module, comprising an array substrate, a driving chip, a pad set and a flexible printed circuit. The array substrate has a top surface and a bottom surface which are oppositely disposed and a through hole penetrating through the top surface to the bottom surface. A conductive material is filled in the through hole to form a conductive portion. The driving chip is arranged at the top surface. A portion of pins of the driving chip is electrically connected to the conductive portion. The pad set is arranged at the bottom surface and right faced to the driving chip. The pad set is electrically connected to the conductive portion. The flexible printed circuit is bonded to the pad set. The screen occupation ratio of the display module of the present application is larger. A terminal is further disclosed.

### CROSS REFERENCE

This application claims the priority of Chinese Patent Application No. 201710191131.6, entitled “Display module and terminal”, filed on Mar. 28, 2017, the disclosure of which is incorporated herein by reference in its entirety.

### FIELD OF THE INVENTION

The present invention relates to a display field, more particularly to a display module and a terminal applied with the display module.

### BACKGROUND OF THE INVENTION

As shown in FIG. 1, the display module of the prior art 200 generally comprises a display panel 201, a driving chip (Driver IC) 202 and a printed circuit board 205. The printed circuit board 205 is an analog and digital signals transmission medium. At present, the manner that the display module 200 applied in the terminal transmits signals to the driving chip 202 on the display panel 201 is: the display panel 201 comprises an active area 2011 and a side frame area 2012 at one side of the active area 2011, the driving chip 202 is arranged in the side frame area 2012 and fixed on the front surface of the array substrate 203, a portion of pins 2021 of the driving chip 202 is electrically connected to the signal lines in the active area 2011, a pad set 204 is arranged at one side of the driving chip 202 remote from the active area 2011, the pad set 204 is similarly arranged on the front surface of the array substrate 203 and a bonding area (Border area) 2013 is formed, the other portion of the pins 2021 of the driving chip 202 is electrically connected to the pad set 204, the printed circuit board 205 is fixed in the bonding area 2013 and bonded to the pad set 204 and then, the signals are transmitted to the driving chip 202 via the pad set 204. For ensuring the better contact of the printed circuit board 205 and the pad set 204, the pad length of the pad set 204 has to be sufficient. Then, it results in that the boding area 2013 occupies a larger area to increase the area and ratio of the side frame area 2012 of the display panel 201. The screen occupation ratio of the display module 200 may be worse.

### SUMMARY OF THE INVENTION

An objective of the present invention is to provide a light guide plate and a display module and a terminal having a larger screen occupation ratio.

For realizing the aforesaid objective, the skill solution utilized by the embodiments of the present invention is:

first, provided is a display module, comprising:

an array substrate, having a top surface and a bottom surface which are oppositely disposed and a through hole penetrating through the top surface to the bottom surface, wherein a conductive material is filled in the through hole to form a conductive portion;

a driving chip, arranged at the top surface, wherein a portion of pins of the driving chip is electrically connected to the conductive portion;

a pad set, arranged at the bottom surface and right faced to the driving chip, wherein the pad set is electrically connected to the conductive portion; and

a flexible printed circuit, bonded to the pad set.

The display module further comprises a first pad, the first pad is arranged at the top surface and connected to the conductive portion, an area of the first pad is larger than a cross section area of the through hole, and the pins are connected to the first pad.

The display module further comprises a second pad, the second pad is arranged at the bottom surface and connected to the conductive portion, an area of the second pad is larger than the cross section area of the through hole, and the pins are connected to the second pad.

The first pad, the second pad and the conductive portion are integrally formed.

The first pad, the second pad and the conductive portion are integrally formed.

A first conductive paint layer covering the conductive portion is provided on the top surface, the first conductive paint layer covers the conductive portion, an area of the first conductive paint layer is larger than a cross section area of the through hole, the pins are connected to the first conductive paint layer.

A second conductive paint layer covering the conductive portion is provided on the bottom surface, the second conductive paint layer covers the conductive portion, an area of the second conductive paint layer is larger than the cross section area of the through hole, and the pad set is connected to the second conductive paint layer.

The pins are provided on both sides of a body of the driving chip, the through hole offsets from the body, the conductive portion is connected to an end portion of the pad set.

The pins are provided at a bottom of a body of the driving chip, the through hole right faces the body, the conductive portion is connected to a middle portion of the pad set.

On the other hand, further provided is a terminal, comprising any one of the display modules described as aforementioned.

Compared with prior art, the present invention possesses benefits below: in the display module according to the embodiment of the present invention, the driving chip and the pad set are respectively arranged at two sides of the array substrate which are opposite and the pad set is arranged right facing the driving chip. Therefore, the bonding area for the display module in the prior art can be eliminated to decrease the width of the side frame of the display module and the screen occupation ratio of the display module is larger, which is beneficial for achieving the narrow frame design of the terminal.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is a structure diagram of a display module in prior art.

FIG. 2 is a top view diagram of one embodiment of a display module provided by the present invention.

FIG. 3 is a bottom view diagram of the display module shown in FIG. 2.

FIG. 4 is a sectional diagram of one embodiment of a structure in IV-IV position shown in FIG. 2.

FIG. 5 is an enlarged view diagram of one embodiment of a structure in V position shown in FIG. 4.

FIG. 6 is a sectional diagram of another embodiment of a structure in IV-IV position shown in FIG. 2.

FIG. 7 is an enlarged view diagram of another embodiment of a structure in V position shown in FIG. 4.

FIG. 8 is an enlarged view diagram of one another embodiment of a structure in V position shown in FIG. 4.

FIG. 9 is an enlarged view diagram of one another embodiment of a structure in V position shown in FIG. 4.

FIG. 10 is a top view diagram of another embodiment of a display module provided by the present invention.

FIG. 11 is a bottom view diagram of the display module shown in FIG. 10.

FIG. 12 is a sectional diagram of a structure in X-X position shown in FIG. 10.

FIG. 13 is an enlarged diagram of a structure of XII position in FIG. 12.

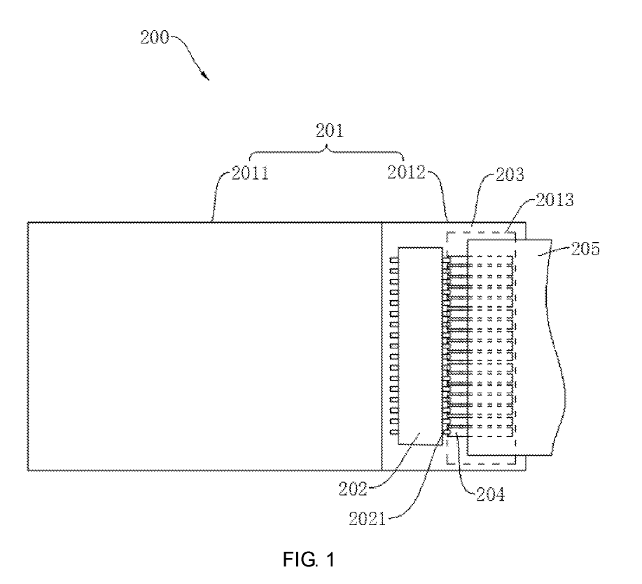

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are merely part of embodiments of the present invention, but not all embodiments. Based on the embodiments of the present invention, all other embodiments to those of ordinary skill in the premise of no creative efforts obtained, should be considered within the scope of protection of the present invention.

Besides, the following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In the description of the application, which needs explanation is that the term “installation”, “connected”, “connection”, “located on . . . ” should be broadly understood unless those are clearly defined and limited, otherwise, For example, those can be a fixed connection, a detachable connection, or an integral connection; those can be a mechanical connection, or an electrical connection; those can be a direct connection, or an indirect connection with an intermediary, which may be an internal connection of two elements. To those of ordinary skill in the art, the specific meaning of the above terminology in the present invention can be understood in the specific circumstances.

Besides, in the description of the present invention, unless with being indicated otherwise, “plurality” means two or more. In the present specification, the term “process” encompasses an independent process, as well as a process that cannot be clearly distinguished from another process but yet achieves the expected effect of the process of interest. Moreover, in the present specification, any numerical range expressed herein using “to” refers to a range including the numerical values before and after “to” as the minimum and maximum values, respectively. In figures, the same reference numbers will be used to refer to the same or like parts.

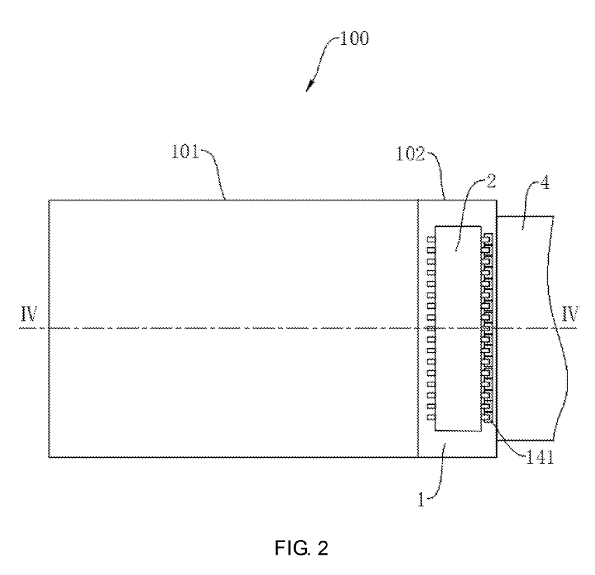

Please refer from FIG. 2 to FIG. 6. The embodiment of the present invention provides a terminal. The terminal comprises a display module 100. The display module 100 is used for realizing the display function. The terminal can be a computer, a television, a tablet or a cellular phone.

The display module 100 comprises an array substrate 1, a driving chip (Driver IC) 2, a pad set 3 and a flexible printed circuit (FPC) 4. The array substrate 1 has a top surface 11 and a bottom surface 12 which are oppositely disposed and a through hole 13 penetrating through the top surface 11 to the bottom surface 12. A conductive material is filled in the through hole 13 to form a conductive portion 14. The driving chip 2 comprises a body 21 and pins 22 connected to the body 21. The driving chip 2 is arranged at the top surface 11. A portion of pins 22 of the driving chip 2 is electrically connected to the conductive portion 14. The pad set 3 is arranged at the bottom surface 12 and right faced to the driving chip 2. The pad set 3 is electrically connected to the conductive portion 14. The flexible printed circuit 4 is bonded to the pad set 3.

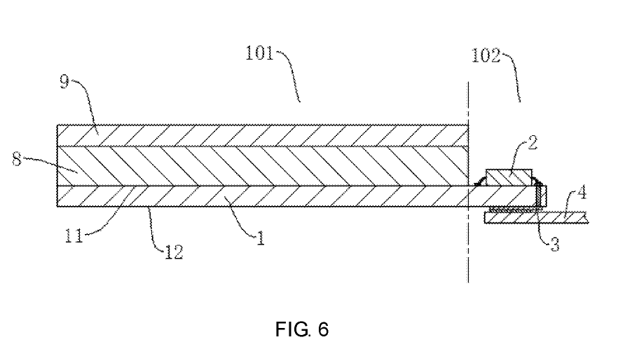

The display module 100 comprises an active area 101 and a side frame area 102 at a side of the active area 101.The array substrate 1 is extended from the active area 101 to the side frame area 102. The driving chip 2, the pad set 3 and the flexible printed circuit 4 are all arranged in the side frame area 102. Another portion of pins 22 of the driving chip 2 is electrically connected to signal lines in the active area 101. The display module 100 can be a liquid crystal display module or an organic light emitting diode display module. As shown in FIG. 4, as the display module 100 is a liquid crystal display module, the display module 100 further comprises a backlight module 5, a liquid crystal layer 6 and a color filter substrate 7.The backlight module 5 is arrange at the bottom surface 12 and in the active area 101. The liquid crystal layer 6 is arranged at the top surface 11 and in the active area 101. The color filter substrate 7 is arranged at one side of the liquid crystal layer 6 remote from the array substrate 1. As shown in FIG. 6, as the display module 100 is an organic light emitting diode display module, the display module 100 further comprises a light emitting layer 8 and a protective layer 9. The light emitting layer 8 is arranged at the top surface 11 and in the active area 101. The protective layer 9 is arranged at one side of the light emitting layer 8 remote from the array substrate 1 for protecting the light emitting layer 8.

In this embodiment, since the driving chip 2 and the pad set 3 of the display module 100 are respectively arranged at two sides of the array substrate 1 which are opposite and the pad set 3 is arranged right facing the driving chip 2. Therefore, the bonding area for the display module 100 in the prior art can be eliminated to decrease the width of the side frame 102 of the display module 100 and the screen occupation ratio of the display module 100 is larger, which is beneficial for achieving the narrow frame design of the terminal.

It can be understood that an amount of the pins 22 electrically connected to the flexible printed circuit 4 is N. N≥2 and is a positive integer. An amount of the through holes 13 is M and M is a positive integer. When M is larger than N, the conductive material is correspondingly filled in the at least N through holes 13 one by one to form at least N conductive portions 14. The pins 22 are correspondingly connected to the conductive portions 14 one by one. As M is smaller than N, the conductive material and the insulation material are filled in the through holes 13 at the same time. The filled insulation material forms insulation portions. The insulation portions insulate the filled conductive material to form a plurality of conductive portions 14. Thus, an amount of the finally formed conductive portions 14 is larger than N. The pins 22 can be correspondingly connected to the conductive portions 14 one by one.

The pad set 3 comprises a plurality of pads 31. The plurality of pads 31 are correspondingly connected to the conductive portions 14 one by one.

The flexible printed circuit 4 comprises a flexible substrate 41 and a plurality of connection pads 42 arranged on the flexible substrate 41. The connection pads 42 are correspondingly connected to the conductive portions 14 one by one.

The conductive material may be copper, tin, silver or gold.

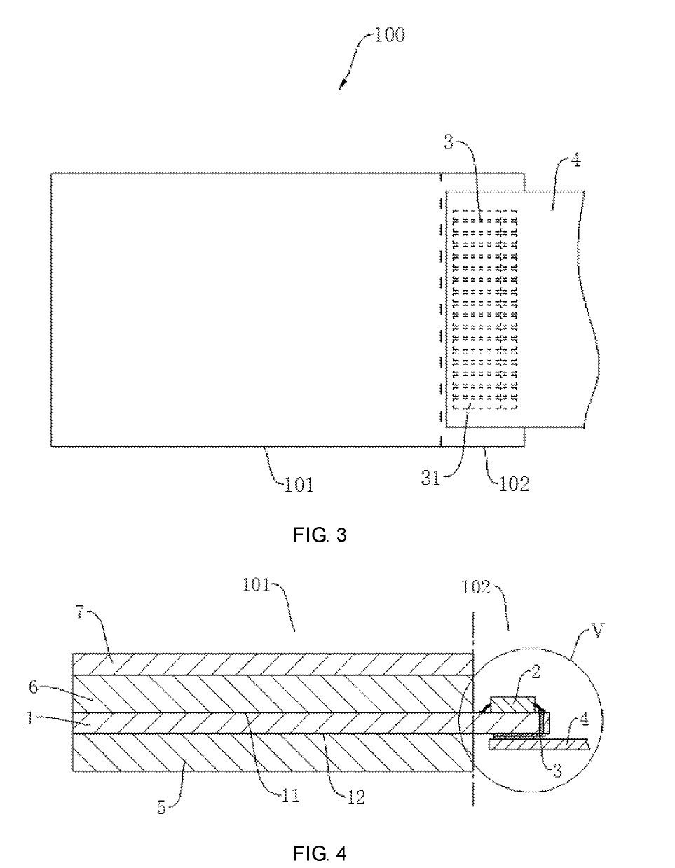

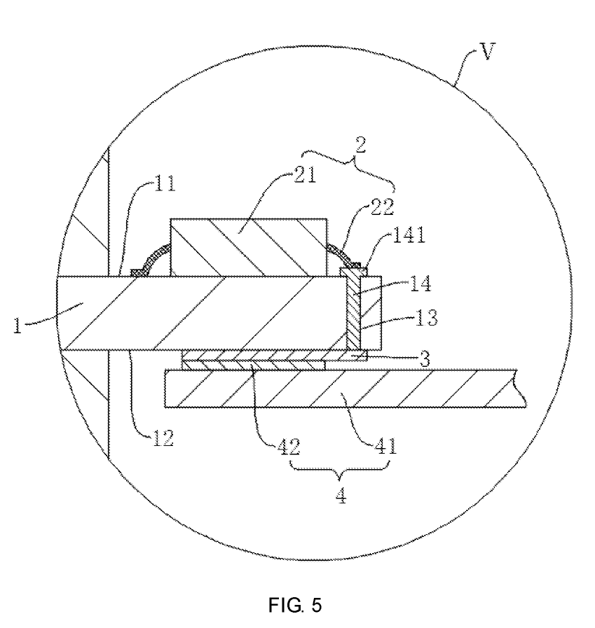

As being a possible embodiment, referring to FIG. 3 and FIG. 5, the display module 100 further comprises a first pad 141. The first pad 141 is arranged at the top surface 11 and connected to the conductive portion 14. An area of the first pad 141 is larger than a cross section area of the through hole 13 (the area of the plane of the through hole 13 perpendicular with the axis thereof). The pins 22 are connected to the first pad 141.

In this embodiment, the through hole 13 with smaller section area can be arranged for ensuring the structure strength of the array substrate 1. Since the area of the first pad 141 is larger than a cross section area of the through hole 13, the area of the first pad 141 is larger and the pins 22 can be easily connected to the first pad 141 and the connection area is larger. Thus, the electrical connection of the pins 22 and the conductive portions 14 is reliable.

An amount of the first pads 141 is equal to an amount of the conductive portions 14.

The first pad 141 and the conductive portion 14 are integrally formed. The connection of the first pad 141 and the conductive portion 14 is reliable and the manufacturing process of the display module 100 can be simplifies to reduce the production cost of the display module 100.

The pins 22 can be welded to the first pad 141. Or, the connection of the pins 22 and the first pad 141 can be achieved with conductive adhesive or conductive film.

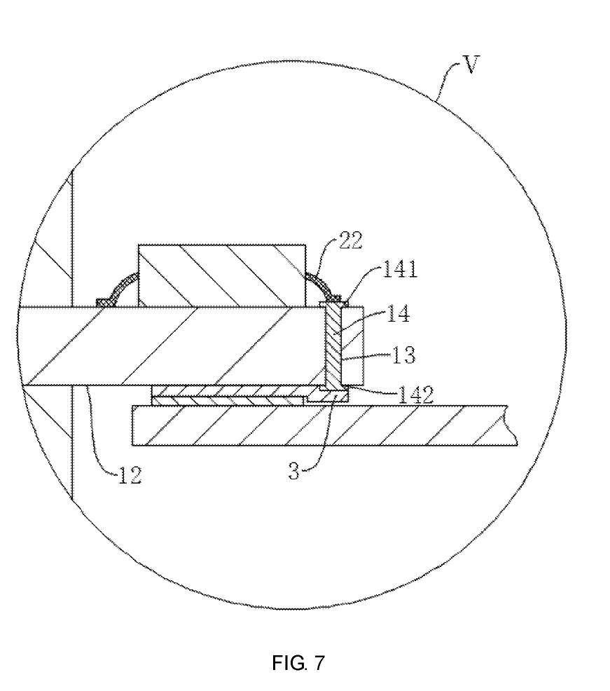

As being a possible embodiment, referring to FIG. 7, the display module 100 comprises a second pad 142 and the first pad 141 in the foregoing embodiment. The second pad 142 is arranged at the bottom surface 12 and connected to the conductive portion 14. An area of the second pad 142 is larger than the cross section area of the through hole 13. The pad set 3 is connected to the second pad 142.

In this embodiment, since the area of the second pad 142 is larger than the cross section area of the through hole 13, the area of the second pad 142 is larger, the pad set 3 can be easily connected to the second pad 142 and the connection area is larger. Thus, the electrical connection of the pad set 3 and the conductive portion 14 is reliable.

An amount of the second pads 142 is equal to the amount of the conductive portions 14.

The first pad 141, the second pad 142 and the conductive portion 14 are integrally formed. Then, the connection of the first pad 141, the second pad 142 and the conductive portion 14 is reliable and the manufacturing process of the display module 100 can be simplifies to reduce the production cost of the display module 100.

The pins 22 can be welded to the first pad 141. Or, the connection of the pins 22 and the first pad 141 can be achieved with conductive adhesive or conductive film. The pad set 3 can be welded to the second pad 142. Or, the connection of the pad set 3 and the second pad 142 can be achieved with conductive adhesive or conductive film.

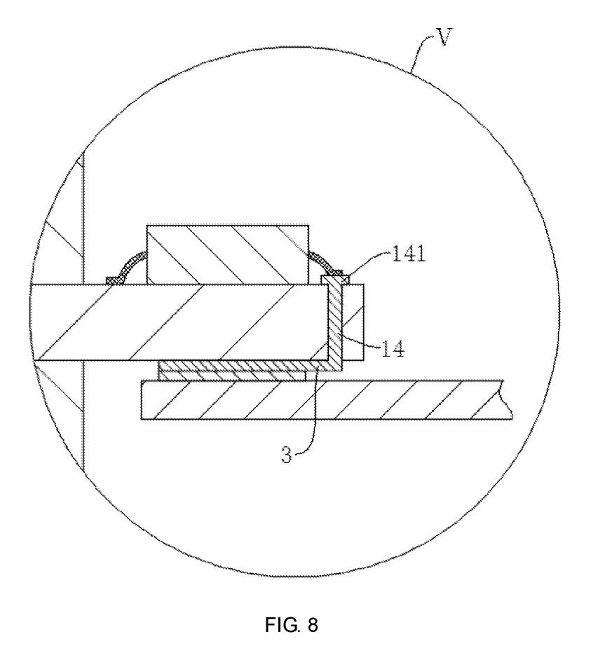

As being another possible embodiment, referring to FIG. 8, the pad set 3 and the conductive portion 14 are integrally formed. The connection of the pad set 3 and the conductive portion 14 is reliable and the production cost of the display module 100 can be reduced. Then, the display module 100 can also be arranged with the first pad 141 in the foregoing embodiment.

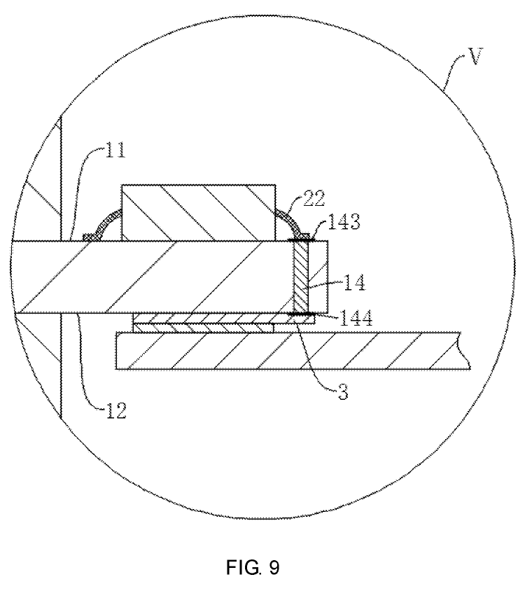

As being one another possible embodiment, referring to FIG. 9, a first conductive paint layer 143 covering the conductive portion 14 is provided on the top surface 11. The first conductive paint layer 143 covers the conductive portion 14. An area of the first conductive paint layer 143 is larger than a cross section area of the through hole 13. The pins 22 are connected to the first conductive paint layer 143. Then, the area of the first conductive paint layer 143 is larger. The pins 22 can be easily connected to the first conductive paint layer 143 and the connection area is larger. Thus, the electrical connection of the pins 22 and the conductive portions 14 is reliable.

An amount of the first conductive paint layers 143 is equal to the amount of the conductive portions 14.

Furthermore, a second conductive paint layer 144 covering the conductive portion 14 is provided on the bottom surface 12. The second conductive paint layer 144 covers the conductive portion 14. An area of the second conductive paint layer 144 is larger than the cross section area of the through hole 13. The pad set 3 is connected to the second conductive paint layer 144. Then, the area of the second conductive paint layer 144 is larger. The pad set 3 can be easily connected to the second conductive paint layer 144 and the connection area is larger. Thus, the electrical connection of the pad set 3 and the conductive portion 14 is reliable.

An amount of the second conductive paint layer 144 is equal to the amount of the conductive portions 14.

The first conductive paint layers 143 and the second conductive paint layer 144 can be formed by a coating method.

As being a possible embodiment, referring from FIG. 2 to FIG. 9, the pins 22 of the driving chip 2 are provided on both sides of a body 21 of the driving chip 2. The through hole 13 offsets from the body 21. For instance, the through holes 13 can arranged at ends of the pins 22 remote from the body 21 for conveniently achieving the connection of the pins 22 and the conductive portions 14. The conductive portion 14 is connected to an end portion of the pad set 3. Thus, the pad set 3 can be arranged right facing the body 21 for decreasing the width of the side frame 102 in advance.

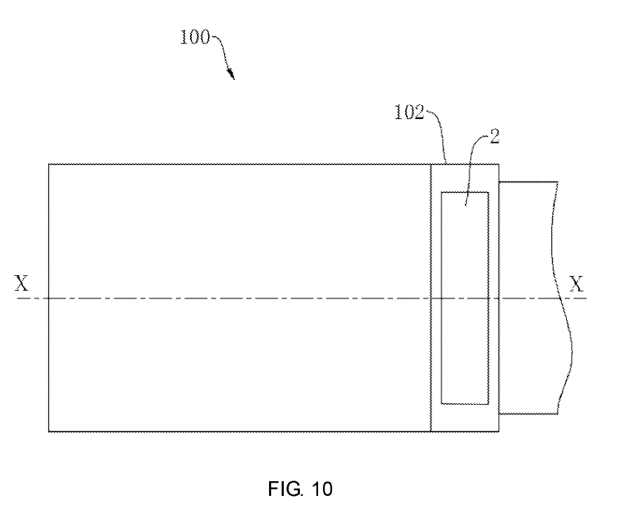

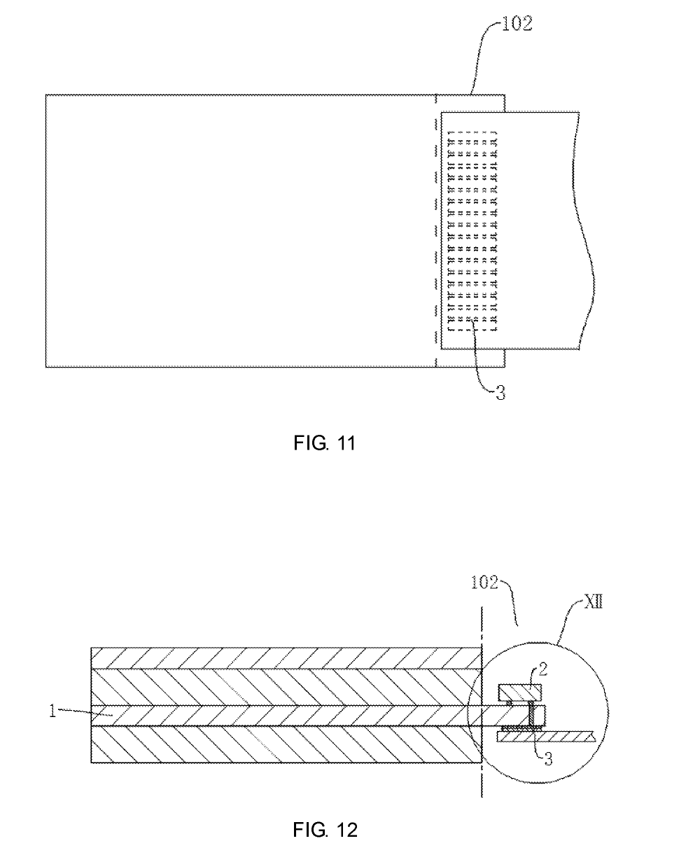

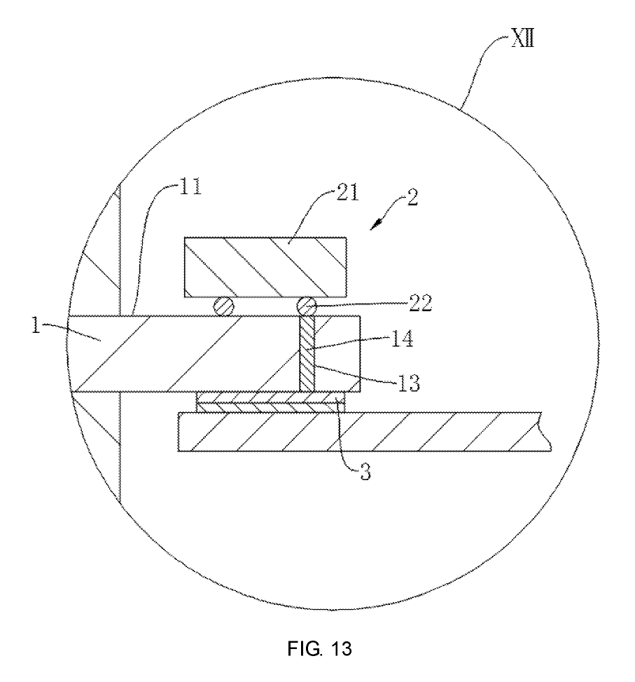

As being a possible embodiment, referring from FIG. 10 to FIG. 13, the pins 22 of the driving chip 2 are arranged at a bottom of the body 21 of the driving chip 2. The driving chip 2 is a flip chip. The pins 22 are solder balls provided below the body 21. The solder balls are arranged between the body 21 and the top surface 11 of the array substrate 1.The through hole 13 right faces the body 21. The conductive portion 14 is connected to a middle portion of the pad set 3.

In this embodiment, since the pins 22 are provided at the bottom of the body 21, the through hole 13 can right face the body 21. Thus, the space at the side of the driving chip 2 can be saved for decreasing the width of the side frame 102 of the display module 100 in advance.

Furthermore, two ends of the conductive portion 14 of this embodiment can be similarly arranged with pads (the first pad 141 and the second pad 142 of the foregoing embodiment as illustration) or conductive paint layers (the first conductive paint layers 143 and the second conductive paint layer 144 of the foregoing embodiment as illustration) having a larger area, for ensuring the reliable connection between the conductive portion 14 and the pin 22, the pad set 3.

The detail description has been introduced above for the embodiment of the invention. Herein, a specific case is applied in this article for explain the principles and specific embodiments of the present invention have been set forth. The description of the aforesaid embodiments is only used to help understand the method of the present invention and the core idea thereof; meanwhile, for those of ordinary skill in the art, according to the idea of the present invention, there should be changes either in the specific embodiments and applications but in sum, the contents of the specification should not be limitation to the present invention.

What is claimed is:

1. A display module, comprising:
an array substrate, having a top surface and a bottom surface which are oppositely disposed and a through hole penetrating through the top surface to the bottom surface, wherein a conductive material is filled in the through hole to form a conductive portion;
a driving chip, arranged at the top surface, wherein a portion of pins of the driving chip is electrically connected to the conductive portion;
a pad set, arranged at the bottom surface and right faced to the driving chip, wherein the pad set is electrically connected to the conductive portion; and
a flexible printed circuit, bonded to the pad set.

2. The display module according to claim 1, wherein the display module further comprises a first pad, the first pad is arranged at the top surface and connected to the conductive portion, an area of the first pad is larger than a cross section area of the through hole, the pins are connected to the first pad.

3. The display module according to claim 2, wherein the display module further comprises a second pad, the second pad is arranged at the bottom surface and connected to the conductive portion, an area of the second pad is larger than the cross section area of the through hole, the pins are connected to the second pad.

4. The display module according to claim 3, wherein the first pad, the second pad and the conductive portion are integrally formed.

5. The display module according to claim 1, wherein the pad set and the conductive portion are integrally formed.

6. The display module according to claim 1, wherein a first conductive paint layer covering the conductive portion is provided on the top surface, the first conductive paint layer covers the conductive portion, an area of the first conductive paint layer is larger than a cross section area of the through hole, the pins are connected to the first conductive paint layer.

7. The display module according to claim 6, wherein a second conductive paint layer covering the conductive portion is provided on the bottom surface, the second conductive paint layer covers the conductive portion, an area of the second conductive paint layer is larger than the cross section area of the through hole, the pad set is connected to the second conductive paint layer.

8. The display module according to claim 1, wherein the pins are provided on both sides of a body of the driving chip, the through hole offsets from the body, the conductive portion is connected to an end portion of the pad set.

9. The display module according to claim 4, wherein the pins are provided on both sides of a body of the driving chip, the through hole offsets from the body, the conductive portion is connected to an end portion of the pad set.

10. The display module according to claim 1, wherein the pins are provided at a bottom of a body of the driving chip, the through hole right faces the body, the conductive portion is connected to a middle portion of the pad set.

11. A terminal, comprising a display module, wherein the display module comprises:
an array substrate, having a top surface and a bottom surface which are oppositely disposed and a through hole penetrating through the top surface to the bottom surface, wherein a conductive material is filled in the through hole to form a conductive portion;
a driving chip, arranged at the top surface, wherein a portion of pins of the driving chip is electrically connected to the conductive portion;
a pad set, arranged at the bottom surface and right faced to the driving chip, wherein the pad set is electrically connected to the conductive portion; and
a flexible printed circuit, bonded to the pad set.

12. The terminal according to claim 11, wherein the display module further comprises a first pad, the first pad is arranged at the top surface and connected to the conductive portion, an area of the first pad is larger than a cross section area of the through hole, the pins are connected to the first pad.

13. The terminal according to claim 12, wherein the display module further comprises a second pad, the second pad is arranged at the bottom surface and connected to the conductive portion, an area of the second pad is larger than the cross section area of the through hole, the pins are connected to the second pad.

14. The terminal according to claim 13, wherein the first pad, the second pad and the conductive portion are integrally formed.

15. The terminal according to claim 11, wherein the pad set and the conductive portion are integrally formed.

16. The terminal according to claim 11, wherein a first conductive paint layer covering the conductive portion is provided on the top surface, the first conductive paint layer covers the conductive portion, an area of the first conductive paint layer is larger than a cross section area of the through hole, the pins are connected to the first conductive paint layer.

17. The terminal according to claim 16, wherein a second conductive paint layer covering the conductive portion is provided on the bottom surface, the second conductive paint layer covers the conductive portion, an area of the second conductive paint layer is larger than the cross section area of the through hole, the pad set is connected to the second conductive paint layer.

18. The terminal according to claim 11, wherein the pins are provided on both sides of a body of the driving chip, the through hole offsets from the body, the conductive portion is connected to an end portion of the pad set.

19. The terminal according to claim 14, wherein the pins are provided on both sides of a body of the driving chip, the through hole offsets from the body, the conductive portion is connected to an end portion of the pad set.

20. The terminal according to claim 11, wherein the pins are provided at a bottom of a body of the driving chip, the through hole right faces the body, the conductive portion is connected to a middle portion of the pad set.
